(19) United States
(12) Patent Application Publication
(10) Pub. No.: US 2026/0042554 A1
(43) Pub. Date: Feb. 12, 2026

(54) ANGLES-ONLY INITIAL ORBIT DETERMINATION TECHNIQUE

(71) Applicant: The Aerospace Corporation, El Segundo, CA (US)

(72) Inventors: Matthew C. BRITTON, Rancho Palos Verdes, CA (US); Ronald M. BLOOM, Los Angeles, CA (US)

(73) Assignee: The Aerospace Corporation, El Segundo, CA (US)

(21) Appl. No.: 18/798,232

(22) Filed: Aug. 8, 2024

(51) Int. Cl. B64G 3/00; G01B 11/26

(52) U.S. Cl. CPC B64G 3/00; G01B 11/26

(57) ABSTRACT

A computer-implement method and apparatus for performing an angles-only initial orbit determination includes specifying input data to an algorithm, and determining a bounded region in a range-range space of candidate orbital solutions. The computer-implement method and apparatus also includes implementing a grid to a finite region of the range-range space, and computing Keplerian orbital properties on the grid. The computer-implement method and apparatus further includes evaluating quality of fit over angle-angle measurements to identify one or more candidate solutions, and polishing each of the one or more identified candidate solutions. The computer-implement method and apparatus also includes evaluating range-range covariance and state covariance for each of the one or more identified candidate solutions, and clustering the one or more identified candidate solutions into distinct groups based on the range-range covariance.

### FIELD

The present invention relates to a technique for angles-only initial orbit determination.

### BACKGROUND

An electro-optical sensor is only capable of measuring the angular location of an object. Such a measurement is not sufficient to determine an orbital solution for a satellite. Instead, a sequence of such measurements is required for initial orbit determination (IOD), during which the sensor and target move with respect to each other. This relative motion provides the triangulation required to determine the target orbit. The IOD problem displays a rich set of behaviors arising from the nonlinear nature of Keplerian propagation and the wide variety of sensor-target engagement geometries that arise in practice. The resulting nonlinear solution space often displays multiple minima corresponding to multiple candidate orbital solutions.

The problem of initial orbit determination from angle-angle measurements was treated by Laplace in the 1700's and Gauss in the 1800's. The most recent substantive contribution in this field was work by Gooding in the mid-1990s. Gooding's work brought out the nonlinear features of the problem and addressed these via a constrained nonlinear optimization procedure based on a Lambert solver.

However, the algorithm described by Gooding is limited to three measurements, does not use a robust scheme for initialization of the nonlinear optimizer, and therefore, cannot guarantee convergence, cannot identify multiple solutions, and does not provide a state covariance estimate.

Accordingly, an improved algorithm for angles-only initial orbit determination may be beneficial.

### SUMMARY

Certain embodiments of the present invention may provide solutions to the problems and needs in the art that have not yet been fully identified, appreciated, or solved by current orbital measurement technologies. There is a need to know the position and velocity of a satellite at a particular time. Once this is known, the satellite can be propagated in its orbit using Kepler's laws to find its location at a future (or prior) time. In short, angles only IOD relate to inferring an orbit from angular measurements acquired with one or more telescopes. These telescopes can be on the ground or in space.

In one embodiment, a computer-implemented method for performing an angles-only initial orbit determination includes specifying, by at least one processor, input data to an algorithm, and determining, by the at least one processor, a bounded region in a range-range space limited by eccentricity. The method also includes implementing, by the at least one processor, a grid to a finite region of the range-range space, and computing Keplerian orbital properties on the grid. The method further includes evaluating, by the at least one processor, quality of fit over angle-angle measurements to identify one or more candidate solutions, and polishing, by the at least one processor, each of the one or more identified candidate solutions. The method also includes evaluating, by the at least one processor, range-range covariance and state covariance for each of the one or more identified candidate solutions, and clustering, by the at least one processor, the one or more identified candidate solutions into distinct groups based on the range-range covariance.

In another embodiment, a system configured to perform an angles-only initial orbit determination includes at least one processor and memory comprising a set of instructions. The set of instructions is configured to cause the at least one processor to execute specifying input data to an algorithm and determining a bounded region in a range-range space limited by eccentricity. The set of instructions is further configured to cause the at least one processor to execute implementing a grid to a finite region of the range-range space, computing Keplerian orbital properties on the grid, and evaluating quality of fit over angle-angle measurements to identify one or more candidate solutions. The set of instructions is further configured to cause the at least one processor to polish each of the one or more identified candidate solutions, evaluating range-range covariance and state covariance for each of the one or more identified candidate solutions, and clustering the one or more identified candidate solutions into distinct groups based on the range-range covariance.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not, therefore, to be considered to be limiting in its scope, the invention will be described and explained with additional specificity and detail through the use of the accompanying drawings, in which:

FIG. 1 is a flow diagram illustrating a method for angles only initial orbit determination, according to an embodiment of the present invention.

FIG. 2 is a diagram illustrating a technique for bounding the slant-range search space, according to an embodiment of the present invention.

FIG. 3 is a method for performing a two-stage search, according to an embodiment of the present invention.

FIG. 4A is a graph illustrating how the algorithm identifies tangent points to a region of eccentricity of <1, according to an embodiment of the present invention.

FIG. 4B is a graph illustrating how the algorithm uses the interior point identified above to identify contour at, according to an embodiment of the present invention.

FIG. 4C is a graph illustrating how the search from the interior point along the ray is bounded by external values of ρ₁ and ρ₂, according to an embodiment of the present invention.

FIGS. 5A-D illustrate graphs showing a grid space that is 265×265 with spacing of 188 km, according to an embodiment of the present invention.

FIGS. 6A-6C are graphs illustrating function surfaces that have multiple minima or exhibit long valleys of candidate solutions, according to an embodiment of the present invention.

FIG. 7, which is a graph showing a small region of the two dimensional log objective function surface in (ρ₁, ρ₂) space, according to an embodiment of the present invention.

FIG. 8, for example, is a graph illustrating four candidates and three candidates clustered to identify two distinct solutions, according to an embodiment of the present invention.

FIG. 9 is an architectural diagram illustrating a computing system configured to perform angles-only IOD, according to an embodiment of the present invention.

### DETAILED DESCRIPTION OF THE EMBODIMENTS

Some embodiments generally pertain to an algorithm for angles only IOD. This algorithm improves upon state-of-the-art performance of angles-only IOD in several areas. For example, the algorithm guarantees convergence, enumerates all possible orbital solutions, and permits use of an arbitrary number of angle-angle measurements, allowing each candidate orbital solution to be identified and eliminated if/when statistically precluded by subsequent measurements. The algorithm may also provide both a state and state covariance estimate that is updated and refined as subsequent measurements are incorporated. The algorithm may be implemented in a software application, may be evaluated in thousands of engagement scenarios, and may execute on timescales of order seconds on a desktop workstation.

In some embodiment, the angles-only IOD algorithm uses angle-angle measurements from an electro-optical sensor to determine the Keplerian orbit of a satellite. Angle-angle measurements are only sensitive to location in the sky and do not provide range information. Consequently, multiple angle-angle measurements are required to critically determine or overdetermine the Keplerian orbital solution. A minimum of three measurements are required to critically determine the orbit, and more than three measurements allow the orbit to be overdetermined.

Angles-only IOD is a nonlinear technique, and error propagation through the nonlinear fit to determine the quality of the fit may be essential.

Traditionally angles-only IOD selects two preferred measurements as “Lambert anchors”. Generally, a standard approach is used. The search for solutions is carried out as a constrained nonlinear optimization, in which the sensor-target ranges at the two Lambert anchor measurements and establishes the orbital hypothesis that defines the criteria for optimization. This is a two-dimensional search space in the two Lambert anchor ranges.

Specifically, call this the constrained nonlinear optimization in range-range space.

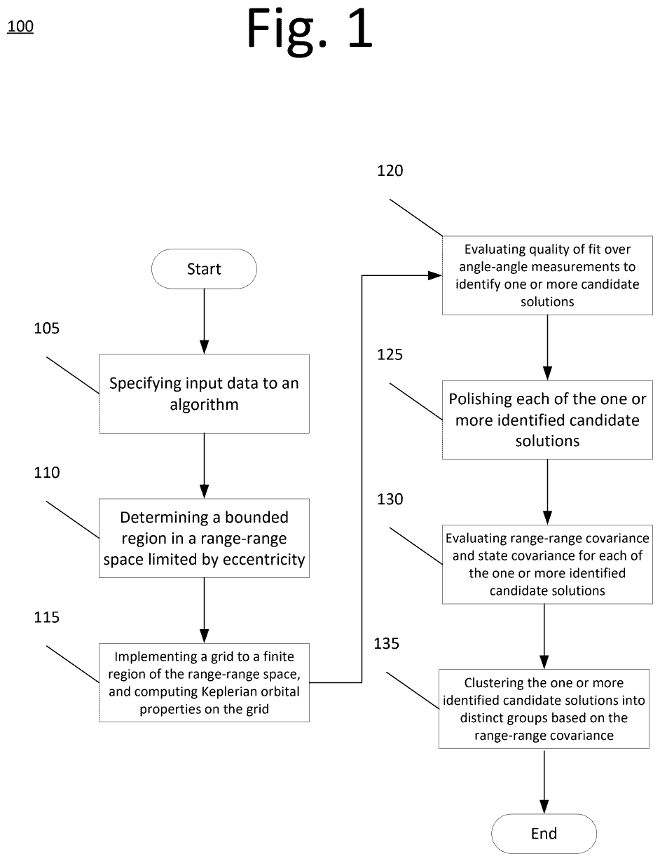

FIG. 1 is a flow diagram illustrating a method 100 for angles only initial orbit determination, according to an embodiment of the present invention. In some embodiments, method 100 includes specifying at 105 input data to the algorithm. In some embodiments, the input data to the algorithm includes a list of records, each obtained at a specific epoch. Each record may include an epoch, an ECI coordinate of the sensor performing the angle-angle measurement of the target, an angle-angle measurement of the target, and a noise covariance, which encodes the errors in the angle-angle measurement.

TABLE 1
Angle-Angle Observation Set

| | | | Target |
|---|---|---|---|
| | Sensor | Target | Noise |
| | ECI x, y, z | RA, DEC | Covariance |
| Epoch | (km) | (deg) | (rad²) |
| 2015 Mar. 21 | (−2e−07, | 228.337, 8.871 | 2.35044e−110 |
| 20:00:00 | 42000, 0) | | 2.35044e−110 |
| 2015 Mar. 21 | (−3551.45, | 143.05, 9.7824 | 2.35044e−110 |
| 20:20:00 | 5297.91, 0) | | 2.35044e−110 |
| 2015 Mar. 21 | (−3692.02, | 230.025, 7.94961 | 2.35044e−110 |
| 20:20:00 | 41837.4, 0) | | 2.35044e−110 |
| 2015 Mar. 21 | (−4000.87, | 151.249, 8.49907 | 2.35044e−110 |
| 20:40:00 | 4967.26, 0) | | 2.35044e−110 |
| 2015 Mar. 21 | (−7355.46, | 232.29, 7.00687 | 2.35044e−110 |
| 20:40:00 | 41350.9, 0) | | 2.35044e−110 |
| 2015 Mar. 21 | (−4419.67, | 158.544, 7.23409 | 2.35044e−110 |
| 21:00:00 | 4598.61, 0) | | 2.35044e−110 |
| 2015 Mar. 21 | (−10962, | 234.956, 6.06411 | 2.35044e−110 |
| 21:00:00 | 40544.2, 0) | | 2.35044e−110 |
| 2015 Mar. 21 | (−4804.65, | 165.117, 6.00898 | 2.35044e−110 |
| 21:20:00 | 4194.76, 0) | | 2.35044e−110 |

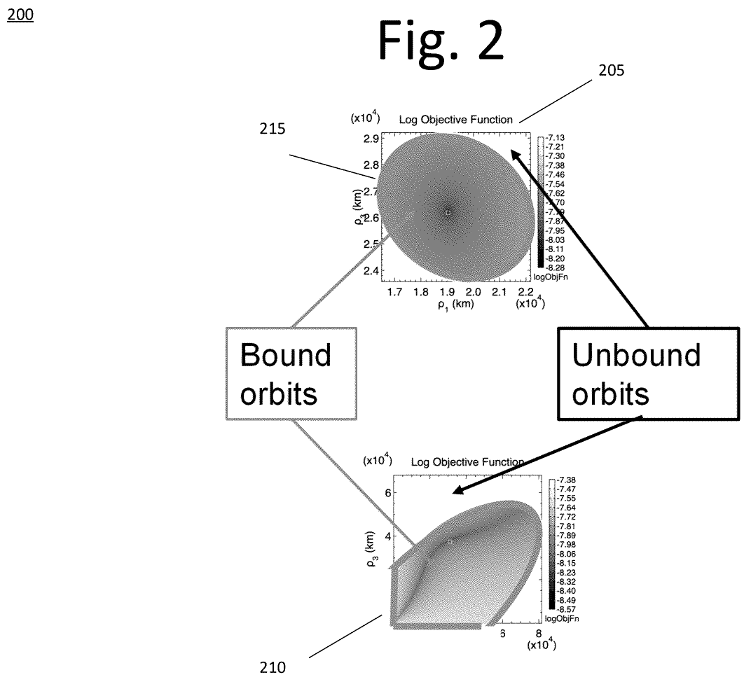

At 110, method 100 includes determining a bounded region in range-range space limited by eccentricity. In FIG. 2, for example, we observe x and y axes, i.e., on the x-axis, is the sensor-target range at the first lambert anchor, ρ₁, and on the y-axis, is the sensor-target range at the second lambert anchor, ρ₂. The two-dimensional space is nominally semi-infinite, since ρ₁ and ρ₂ lie in the range [0,∞].

The problem that arises in a numerical algorithm is to bound these semi-infinite spaces so that a numerical algorithm can perform the constrained nonlinear optimization in finite compute time. In step 110, however, these regions are bounded by constraining the eccentricity of the orbital solution. For orbits that do not escape the Earth's gravitational field, eccentricity<1. This restriction is indicated as 215 contours at right.

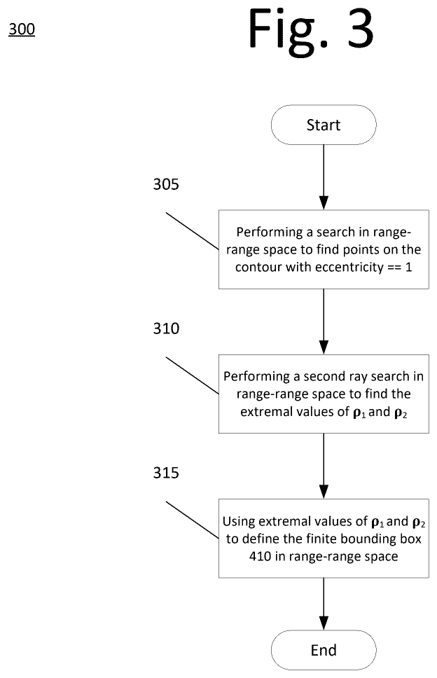

In some embodiments, a bounded region is determined in range-range space limited by eccentricity. For example, a bounded region is determined in range-range space containing orbital solutions with eccentricity less than 1. Using this example, a two stage search is performed. See, for example, FIG. 3, which is a method 300 for performing a two-stage search, according to an embodiment of the present invention.

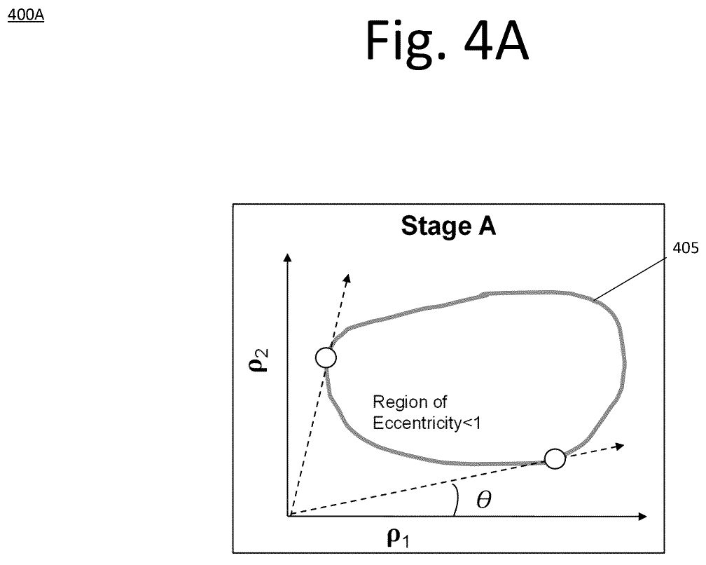

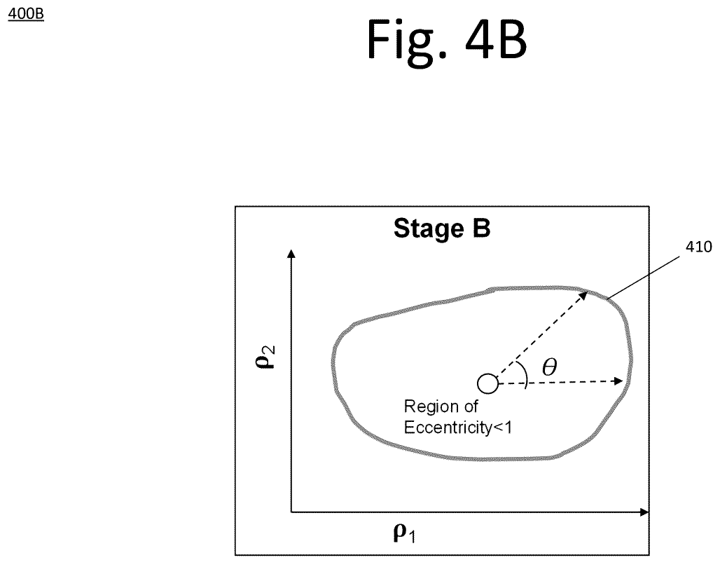

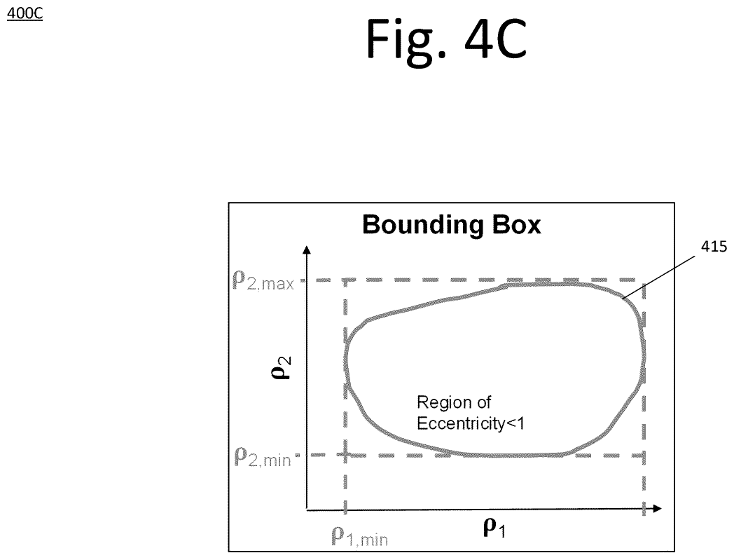

In some embodiments, method 300 begins at 305 with performing a search in range-range space to find points on the contour with eccentricity==1. The step searches along a ray at angle θ seeking a point in range-range space with eccentricity<1. If the search does not find the points, the set advances θ and repeats the ray search until two points are identified, as shown below. Next, at 310, method 300 includes performing a second ray search in range-range space to find the extremal values of ρ₁ and ρ₂. The two extremal points from stage A are used to select an interior point. See, for example, FIG. 4A, which is a graph 400A illustrating how the algorithm identifies tangent points to a region of eccentricity of <1, according to an embodiment of the present invention. Once these tangent points have been identified, the algorithm selects a point within the region with eccentricity<1. In the next step of the algorithm, this interior point is used in a ray search about the interior point to identify contour 405.

At 315, method 300 also includes using extremal values of ρ₁ and ρ₂ to define the finite bounding box 410 in range-range space. See, for example, FIG. 4B, which is a graph 400B illustrating how the algorithm uses the interior point identified above to identify contour at 405, according to an embodiment of the present invention. For example, the algorithm traces rays from the interior point to the contour, searching for the eccentricity==1 point in the two-dimensional (p1, p2) space. This procedure is repeated over the range theta=[0,360] degrees to map the eccentricity==1 boundary.

Specifically, the bounded region 415 of range-range space lies in the range ρ_{1,min}<ρ₁<ρ_{1,max}. and ρ_{2,min}<ρ₂<ρ_{2,max}. See, for example, FIG. 4C, which is a graph 400C illustrating how the search from the interior point along the ray is bounded by external values of ρ₁ and ρ₂, according to an embodiment of the present invention.

Returning to FIG. 1, at 115, method 100 includes implementing a grid on the finite region of range-range space, followed by computing Keplerian orbital properties on the grid. Let's consider only the Lambert anchors and disregard the other angle-angle measurements. In this example, each point within the bounded range-range space represents a valid closed Keplerian orbital solution. It is straightforward to make color gradient plots of the Keplerian parameters over this region. The method, however, is to grid the range-range space and compute the parameters at each point on the grid.

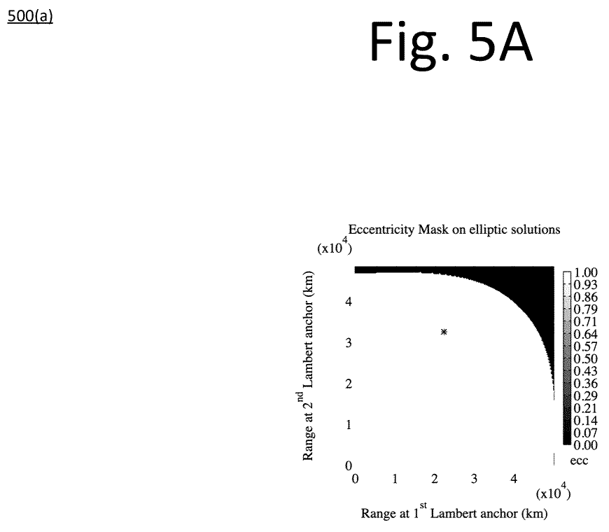

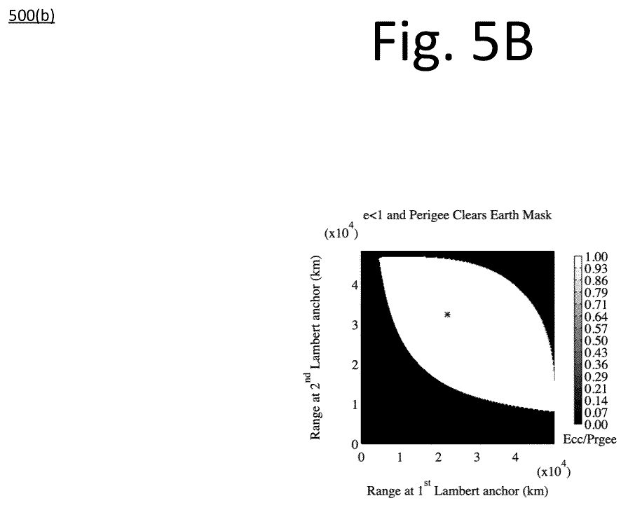

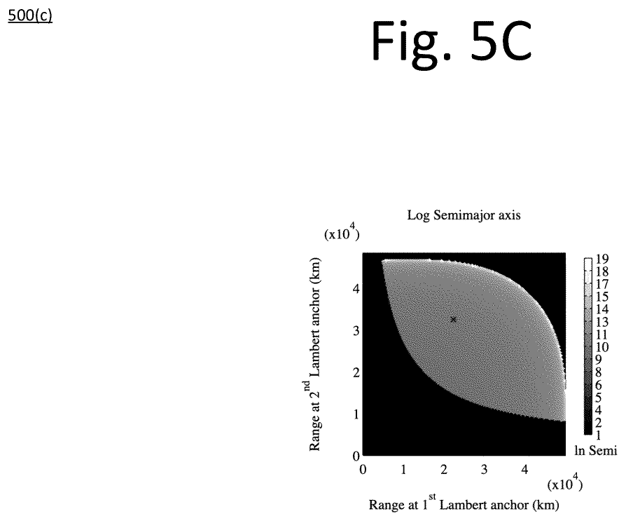

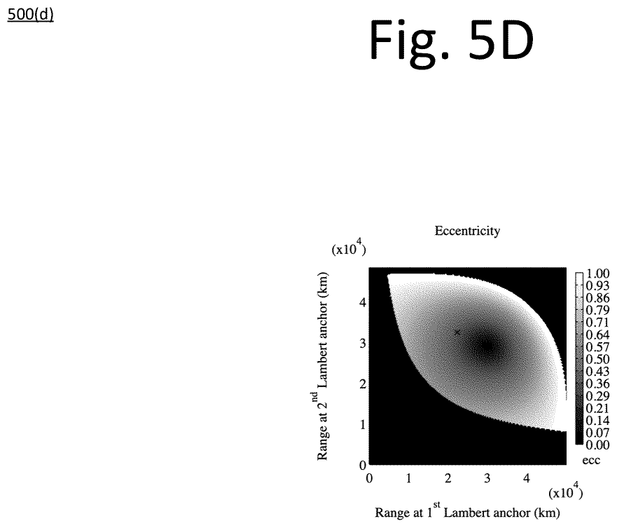

FIGS. 5A-D illustrate graphs 500(a)-(d) showing a grid space that is 265×265 with spacing of 188 km, according to an embodiment of the present invention. In this embodiment, the eccentricity being less than 1 mask is shown in graph 500(a). Regions of the bounded range-range space may be excluded based on whether these orbital solutions would hit the earth. See graph 500(b). The final two graphs 500(c) and 500(d) display In (semimajor axis) and eccentricity.

Returning to FIG. 1, at 120, method 100 continues with evaluating quality of fit over angle-angle measurements to identify candidate solutions. It should be appreciated that the preceding steps used two of the angle-angle measurements, which were selected as the Lambert anchors. These two measurements sufficed to define range-range space, identify the finite region of this space over which eccentricity<1, and examine the Keplerian orbital properties over this bounded region.

In step 120, the remaining angle-angle measurements are used to discriminate among orbital solutions in this bounded region of range-range space. The procedure is carried out at each point on the grid of range-range space points. Each point on the grid represents a Keplerian orbital solution. This predicts the location of the satellite at each epoch, as shown in Table 1 above. Given the sensor location in this table and the predicted satellite location, a prediction is computed for the target angular location. This prediction is compared to the measurement. See column 3 in Table 1 above. The discrepancy between prediction and measurement is accumulated over all angle-angle measurements in the table. The equation is defined by

$$[ \begin{matrix}Objective \\ Function\end{matrix} ] = F ( {ρ}_{1} , {ρ}_{2} ) = {\sum }_{{angl e}_{{angle}_{measurements}}} {[ y - \tilde{y} ( {ρ}_{1} , {ρ}_{2} ) ]}^{T} {Σ}^{- 1} [ y - \tilde{y} ( {ρ}_{1} , {ρ}_{2} ) ]$$

where the objective function is the Log Objective Function shown in FIG. 2.

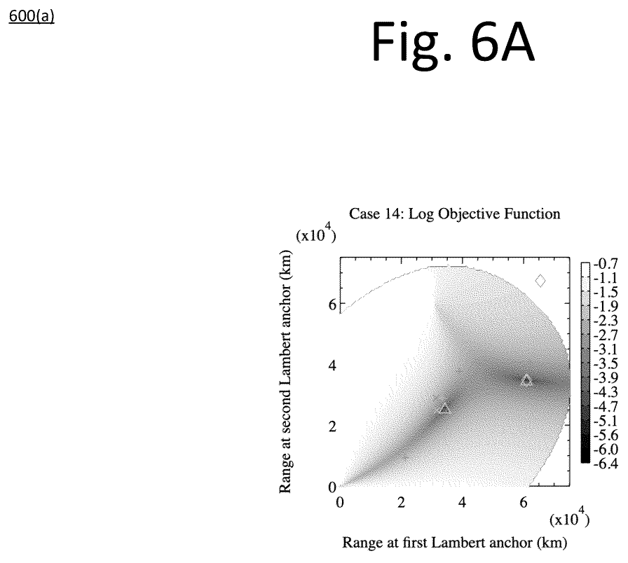

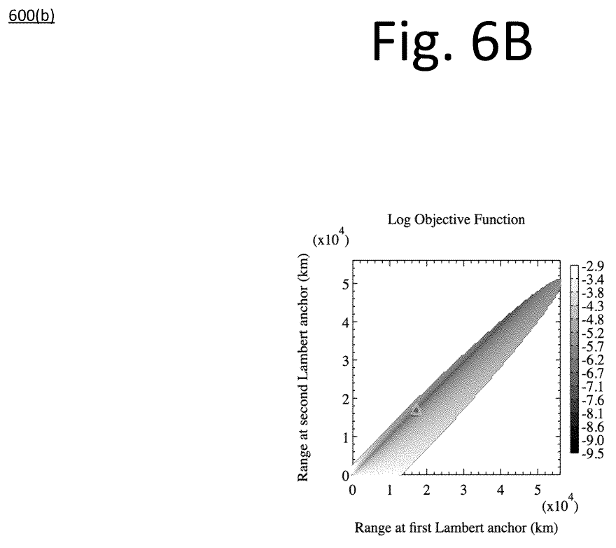

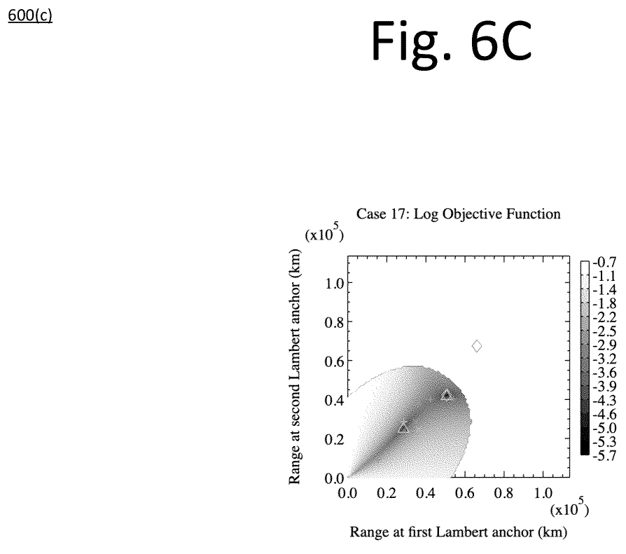

It should be noted that the shape of the objective function surface depends on the number, distribution in time, and geometrical configuration between sensor and target at the time of the measurement. This surface can display multiple local minima, these minima can be difficult to identify due to angle-angle measurement error, the minima can become more distinct as additional angle-angle measurements are acquired and added to the fit, and a global minimum may emerge that uniquely identifies the satellite orbit. FIGS. 6A-6C are graphs 600A-600C illustrating function surfaces that have multiple minima or exhibit long valleys of candidate solutions, according to an embodiment of the present invention. The embodiments described herein allow for the enumeration of all minima and rate each of these candidates based on the value of the objective function at this minimum.

At 125, method 100 includes polishing each candidate solution to refine the estimate. It should be noted that the solution identified in the previous step, i.e., step 120, was the best solution on the grid of solutions. In the example above, this grid spacing was selected to be 188 km. This selection is one of computational practicality, i.e., one cannot sample the grid too finely without expending a lot of computational time. This grid resolution is unrelated to the accuracy of the fit, and would be misleading to quote an answer based on the grid resolution.

To determine a solution with higher accuracy, the fit is improved with a polishing step (i.e., step 125). In this embodiment, a nonlinear solver is seeded with a grid solution and a steepest descent algorithm iterates until a convergence criterion is met. Continuing with the above example, Table 2 shows the unpolished solution at the grid point with minimum objective function 4.9e-8 and the polished solution with objective function 1.66e-19. The nonlinear solver, in this example, has shifted the values of ρ₁ and ρ₂ by a few tens of kilometers to reach this polished solution.

TABLE 2

| Unpolished | | | Polished |
|---|---|---|---|
| ρ₁ | ρ₂ | Obj. Fn | ρ₁ |
| 22418.9142028037 | 32769.2669269644 | 4.92020473771607e−08 | 22393.7389800483 |

Polished

| | | Semi- | |
|---|---|---|---|
| ρ₂ | Obj. Fr | Major (km) | Eccentricity |
| 32795.7830584921 | 1.66072084004508e−19 | 31999.999938905 | 0.329999999989234 |

At 130, method 100 includes evaluating range-range covariance for each candidate solution. In one example, each candidate solution is a coordinate (ρ₁, ρ₂) in range-range space rated by the objective function at that coordinate. The nonlinear nature of this fitting problem precludes the use of a linear approximation for error estimation. Instead, some embodiments use the properties of the objective function surface near (ρ₁, ρ₂) to define a range-range covariance matrix C_{ρρ}.

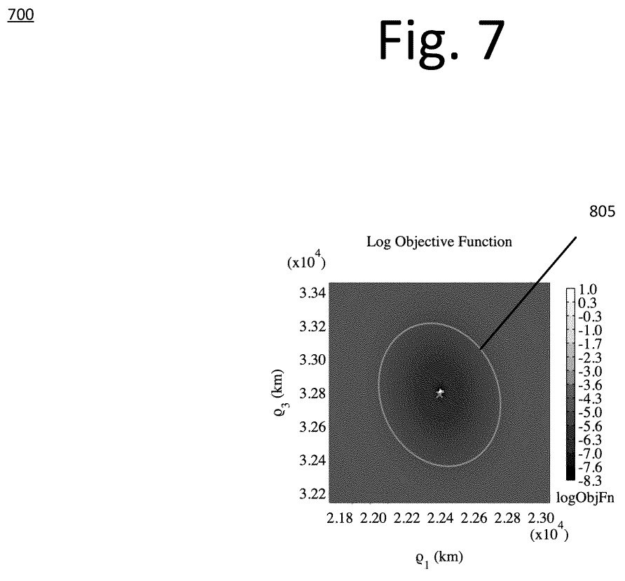

The procedure computes the second derivatives of the objective function surface about the candidate solution. See, for example, FIG. 7, which is a graph 700 showing a small region of the two dimensional log objective function surface in (ρ₁, ρ₂) space, according to an embodiment of the present invention. The algorithm numerically evaluates the Hessian matrix at the minimum to establish a quadratic approximation to the surface. This yields the 2×2 range-range covariance matrix at this candidate solution. In graph 800, curve 805 represents the 1-sigma error ellipse, which is computed from the 2×2 range-range covariance matrix C_{ρρ} shown in Table 3 at center.

TABLE 3

| | |
|---|---|
| C_{ρρ} | 131645.88 −22038.018 |
| (km²) | −22038.018 182427.68 |

The range-range covariance matrix may be converted to a 6×6 state covariance matrix C_{XX} to obtain the state covariance for the candidate solution, in some embodiments. See Table 4 below.

TABLE 4

| Item | | X | Y | Z | V_{X} | V_{Y} | V_{Z} |
|---|---|---|---|---|---|---|---|
| C_{XX} | X | 286511.66 | 10206.226 | −4716.7448 | 30.133044 | 24839.305 | −102531.07 |
| ([km², | Y | 10206.226 | 450883.25 | −1547.3108 | −4.2449096 | −166322.96 | −54918.29 |
| (km/sec)²]) | Z | −4716.7448 | −1547.3108 | 136.4848 | −0.82996019 | −0.068958302 | −0.083498804 |
| | V_{X} | 30.133044 | −4.2449096 | −0.82996019 | 0.0066005801 | 0.13940104 | −0.11729338 |
| | V_{Y} | 24839.305 | −166322.96 | −0.068958302 | 0.13940104 | 164753.33 | 22828.235 |
| | V_{Z} | −102531.07 | −54918.29 | −0.083498804 | −0.11729338 | 22828.235 | 278990.89 |

At 135, method 100 includes clustering the solutions based on range-range covariance. As discussed in step 120, all local minima from the grid search are selected and then polished in step 125. In some embodiments, there may be circumstances where multiple local minima polish to the same solution. This can occur when measurement noise or bias distorts the objective function surface, which is then sampled on a grid. The grid sampling may capture multiple local minima that polish to solutions which lie within the accuracy of the range-range estimate.

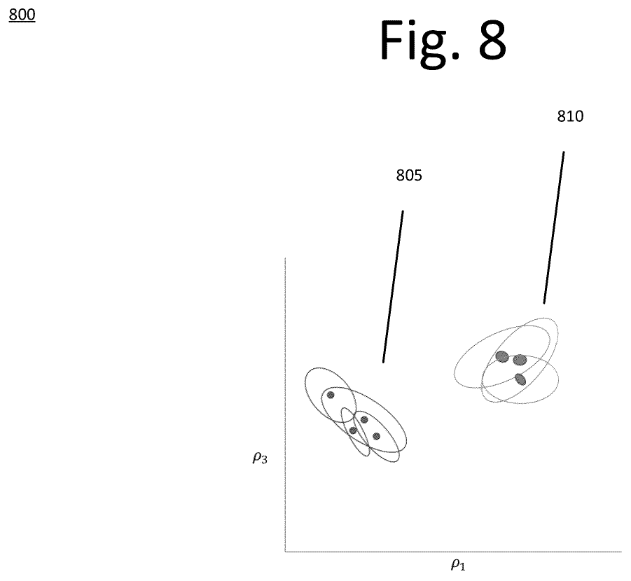

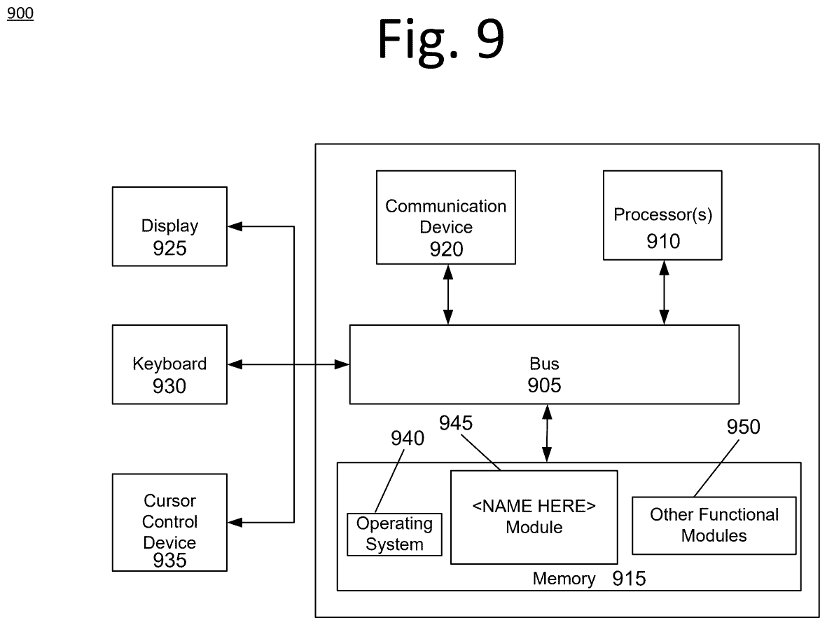

In step 135, the polished candidate solutions are clustered based on the range-range covariance estimates from step 130. FIG. 8, for example, is a graph 800 illustrating four candidates 805 and three candidates 810 clustered to identify two distinct solutions, according to an embodiment of the present invention. The ellipses in FIG. 9 indicate the covariance C_{ρρ} of each polished candidate estimated in step 130. This clustering embodiment groups candidate solutions based on their separation relative to the error estimates from C_{ρρ}. This allows for reporting of solutions to the user without duplicative solutions.

### Bounding a Slant Range Search Space

It should be noted that the two-dimensional (2D) search space over which the constrained nonlinear optimization is performed is semi-infinite. That is, the two ranges r1 and r3, each of which take on values from zero to infinity. Since it is not possible for a computer to search an infinite number of points in a finite compute time, the number of computations is bounded in these embodiments. Existing state of the art fails to limit the number of computations.

In some embodiments, this search space is bounded by computing the region of the space corresponding to elliptical orbits, i.e., only satellites orbiting the Earth, rather than those escaping the Earth's gravitational field. However, it should be appreciated that this algorithm is able to find orbits that are not gravitationally bound to Earth by mapping contours with eccentricity>1.

FIG. 2 is a diagram illustrating a technique 200 for bounding the slant-range search space, according to an embodiment of the present invention. In FIG. 2, the upper plot at right is bounded by a contour corresponding to satellites in bound orbits, shown as 205. A second example is shown at lower right, shown as 210. Each geometric realization of the sensor-target angles-only measurement geometry has a unique bounded search space that must be recomputed computationally.

Some embodiments identify these regions automatically, thereby constraining the grid search to a finite number of hypotheses. See the discussion above with respect to step 110 in FIG. 1.

### Evaluating of Discrete Objective Function and Recording its Grid-Minima on a Gridded Search Space

It should be noted that the two-dimensional search space can contain multiple solutions and that these multiple solutions can be confusers if they are not all enumerated. Examples of search spaces with multiple local minima and long, degenerate valleys are shown in FIGS. 6A-C. FIG. 6A is a graph 600(a) displaying a search space containing two local minima marked, according to an embodiment of the present invention. The angle-angle measurements underlying this search space are consistent with both orbital solutions. This algorithm identifies, rates, and reports state and state covariance of both solutions. FIG. 6B is a graph 600(b) displaying a search space containing a narrow valley of possible solutions with the true minimum marked, according to an embodiment of the present invention. This algorithm identifies the minimum within this valley, polishes the minimum to improve precision, and reports the corresponding state and state covariance. FIG. 6C is a graph 600(c) displaying a search space containing two minima marked, according to an embodiment of the present invention. As in FIG. 6A, the algorithm identifies and reports state and state covariance for both possible orbital solutions.

It should be noted that each realization of this search space arises from the sensor-target geometric configurations in which the angles-only measurements were acquired. Once candidate solutions are identified and enumerated, the candidate solutions are rated according to their objective function. The solution with the smallest objective function is the best candidate.

### Polishing Grid Minima-Nonlinear Optimization

It should be appreciated that each of the minima enumerated in the grid search was used as starting points for the type of search described above and in FIG. 7. This approach refined the solution to an accuracy that is much finer than grid sampling. The grid sampling may be selected fine enough to guarantee that there was only one minimum in each cell of the grid, so there was no risk of falling into a local minimum.

### Clustering and Classification of Polished Candidates

A more general formulation of error analysis is discussed below. For example, a sensitivity analysis of the two-dimensional search space in the vicinity of each candidate solution is executed. For each candidate solution, an elliptical error region is identified. The elliptical error region is defined as a range-range covariance matrix.

The range-range covariance matrix implies a “state covariance matrix”. This is the actual error in the satellite's position and velocity, which encodes the orbital uncertainty. Each sensor-target geometric configuration generates a unique set of solutions.

It should be noted that the calculation of the Crr error ellipse has another application allowing for cluster solutions. In enumerating multiple candidate solutions, multiple solutions, which arise from the same local minimum, are identified. This can happen when polishing grid minima. For example, two candidates can polish to range-range values that are separated by machine precision. Unless there is a way to determine that these are identical, one must carry both solutions and worry about which one is correct. The Crr error ellipse provides a simple way to cluster these solutions, i.e., if they both lie within the ellipse, then they are indistinguishable from error.

FIG. 9 is an architectural diagram illustrating a computing system 900 configured to perform angles-only IOD, according to an embodiment of the present invention. In some embodiments, computing system 900 may be one or more of the computing systems depicted and/or described herein. Computing system 900 includes a bus 905 or other communication mechanism for communicating information, and processor(s) 910 coupled to bus 905 for processing information. Processor(s) 910 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 910 may also have multiple processing cores, and at least some of the cores may be configured to perform specific functions. Multi-parallel processing may be used in some embodiments. In certain embodiments, at least one of processor(s) 910 may be a neuromorphic circuit that includes processing elements that mimic biological neurons. In some embodiments, neuromorphic circuits may not require the typical components of a Von Neumann computing architecture.

Computing system 900 further includes a memory 915 for storing information and instructions to be executed by processor(s) 910. Memory 915 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 910 and may include volatile media, non-volatile media, or both. The media may also be removable, non-removable, or both.

Additionally, computing system 900 includes a communication device 920, such as a transceiver, to provide access to a communications network via a wireless and/or wired connection. In some embodiments, communication device 920 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 920 may include one or more antennas that are singular, arrayed, phased, switched, beamforming, beamsteering, a combination thereof, and or any other antenna configuration without deviating from the scope of the invention.

Processor(s) 910 are further coupled via bus 905 to a display 925, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 925 may be configured as a touch (haptic) display, a three dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 930 and a cursor control device 935, such as a computer mouse, a touchpad, etc., are further coupled to bus 905 to enable a user to interface with a computing system. However, in certain embodiments, a physical keyboard and mouse may not be present, and the user may interact with the device solely through display 925 and/or a touchpad (not shown). Any type and combination of input devices may be used as a matter of design choice. In certain embodiments, no physical input device and/or display is present. For instance, the user may interact with computing system 900 remotely via another computing system in communication therewith, or computing system 900 may operate autonomously.

Memory 915 stores software modules that provide functionality when executed by processor(s) 910. The modules include an operating system 940 for computing system 900. The modules further include an angles-only IOD module 945 that is configured to perform all or part of the processes described herein or derivatives thereof. Computing system 900 may include one or more additional functional modules 950 that include additional functionality.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

The process steps performed in FIG. 1 may be performed by a computer program, encoding instructions for the processor(s) to perform at least part of the process(es) described in FIG. 1, in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 910 of computing system 900 of FIG. 9) to implement all or part of the process steps described in FIG. 9, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method for performing an angles-only initial orbit determination, comprising:
specifying, by at least one processor, input data to an algorithm;
determining, by the at least one processor, a bounded region in a range-range space of candidate orbital solutions;
implementing, by the at least one processor, a grid to a finite region of the range-range space, and computing Keplerian orbital properties on the grid;
evaluating, by at least one processor, quality of fit over angle-angle measurements to identify one or more candidate solutions;
polishing, by at least one processor, each of the one or more identified candidate solutions;
evaluating, by at least one processor, range-range covariance and state covariance for each of the one or more identified candidate solutions; and
clustering, by at least one processor, the one or more identified candidate solutions into distinct groups based on the range-range covariance.

2. The computer-implemented method of claim 1, wherein the input data comprises a list of records, each of which is obtained at a specific epoch, and
each record in the list of records comprises an epoch, an ECI coordinate of the sensor performing the angle-angle measurement of the target, an angle-angle measurement of the target, and a noise covariance.

3. The computer-implemented method of claim 1, wherein the determining of the bounded region comprises constraining the region of candidate solutions in range-range space based on orbital criteria.

4. The computer-implemented method of claim 1, wherein the determining of the bounded region comprises constraining the region of candidate solutions in range-range space based on an eccentricity limit.

5. The computer-implemented method of claim 4, wherein the determining of the bounded region comprises a search procedure,
the search procedure comprising
delineating a closed contour in range-range space on which candidate orbital solutions have eccentricity==1 and inside of which candidate orbital solutions represent closed orbits, having eccentricity less than 1.

6. The computer-implemented method of claim 5, wherein the determining of the closed contour of the bounded region of closed orbital solutions comprises performing a ray search in the range-range space to find extremal values of ρ₁ and ρ₂.

7. The computer-implemented method of claim 6, wherein the determining of the bounded region of the closed orbital solutions comprises using the extremal values of ρ₁ and ρ₂ to define a finite bounding box enclosing the region of the closed orbital solutions in the range-range space.

8. The computer-implemented method of claim 1, wherein the implementing the grid within the bounding box and computing the closed orbital solutions on the grid comprises implementing the grid on the range-range space and computing the orbital parameters by solving an associated Lambert problem at each point on the grid.

9. The computer-implemented method of claim 8, further comprising:
developing a merit function to rate closed orbital solutions on the range-range grid, wherein the developing the merit function comprises
performing Kepler propagation of the associated Lambert solution to the remaining observation positions and epochs and computing a summed weighted quadratic deviance between the observed and predicted angular data.

10. The computer-implemented method of claim 9, further comprising:
identifying a set S of grid minima for use by a nonlinear optimizer, wherein the identifying the set S of the grid minima comprises
evaluating the merit function at all grid cells on the range-range grid and identifying grid cells at which the merit function displays a local minimum.

11. The computer-implemented method of claim 10, further comprising:
establishing a set of candidate closed orbital solutions, wherein the establishing the set of candidate closed orbital solutions comprises
applying a nonlinear optimizer to the set S of grid minima to refine the closed orbital solutions to a resolution finer than the grid cell spacing.

12. The computer-implemented method of claim 11, further comprising:
performing computation of a 2×2 range-range covariance and 6×6 state covariance matrices associated with the set of candidate orbital state solutions, wherein the performing of the computation comprises
evaluating the second-order Taylor series expansion in angular coordinates to the merit function to obtain the 2×2 range-range covariance matrix, and
performing a Taylor series expansion in the Keplerian orbital parameters to obtain the 6×6 state covariance matrix.

13. The computer-implemented method of claim 12, further comprising:
establishing a minimal set of closed orbital solutions, wherein the establishing the minimal set comprises
clustering of the one or more identified candidate solutions using the 2×2 range-range covariance matrices.

14. A system configured to perform an angles-only initial orbit determination, comprising:
at least one processor; and
memory comprising a set of instructions, wherein
the set of instructions are configured to cause the at least one processor to execute:
specifying input data to an algorithm;
determining a bounded region in a range-range space limited by eccentricity;
implementing a grid to a finite region of the range-range space, and computing Keplerian orbital properties on the grid;
evaluating quality of fit on the grid over angle-angle measurements to identify one or more grid minima solutions;
polishing each of the one or more identified grid minima solutions to yield corresponding polished candidate solutions;
evaluating 2×2 range-range covariance matrix and 6×6 state covariance matrix for each of the one or more polished candidate solutions; and
clustering the one or more identified polished candidate solutions into distinct groups based on the range-range covariance.

15. The system of claim 14, wherein the input data comprises a list of records, each of which is obtained at a specific epoch, and
each record in the list of records comprises an epoch, an ECI coordinate of the sensor performing the angle-angle measurement of the target, an angle-angle measurement of the target, and a noise covariance.

16. The system of claim 14, wherein the set of instructions are further configured to cause the at least one processor to execute determining the bounded region of range-range space by constraining the eccentricity of an orbital solution to be less than or equal to 1.

17. The system of claim 14, wherein the set of instructions are further configured to cause the at least one processor to execute performing a ray search in bounded region of the range-range space to find extremal values of ρ₁ and ρ₂.

18. The system of claim 17, wherein the set of instructions are further configured to cause the at least one processor to execute using the extremal values of ρ₁ and ρ₂ to define a finite bounding box in the range-range space.

19. The system of claim 14, wherein the set of instructions are further configured to cause the at least one processor to execute
implementing the grid on the range-range space and computing a merit function for orbital parameters parameters at each point on the grid, and seeking the grid points at which the merit function exhibits local minimum; and
using the grid minima as initial values in a nonlinear optimization to produce a set of polished candidate orbital solutions as well as 2×2 range-range and 6×6 orbital state covariance matrices.

20. The system of claim 14, wherein the set of instructions are further configured to cause the at least one processor to execute clustering polished candidate solutions based on the range-range covariance estimates.
